(19) United States
(12) Patent Application Publication
(10) Pub. No.: US 2022/0337436 A1
(43) Pub. Date: Oct. 20, 2022

(54) Method and System for a Decentralized Transactional Communication Protocol

(71) Applicant: ZEU TECHNOLOGIES, INC., Montreal (CA)

(72) Inventors: Jean-Philippe BEAUDET, Montreal (CA); Patricia POPERT-FORTIER, Dorval (CA); Yuming QIAN, Richmond Hill (CA)

(73) Assignee: ZEU TECHNOLOGIES, INC., Montreal, QC (CA)

(21) Appl. No.: 17/635,547

(22) PCT Filed: Aug. 17, 2020
(86) PCT No.: PCT/CA2020/051124

§ 371 Date: Feb. 15, 2022

Related U.S. Application Data
(60) Provisional application No. 62/888,091, filed on Aug. 16, 2019.

(30) Foreign Application Priority Data
Jan. 20, 2020 (CA) PCT/CA2020/050056
Aug. 5, 2020 (CA) PCT/CA2020/051065

(51) Int. Cl. H04L 9/00; H04L 9/08; H04L 9/32; H04L 69/16; G06F 9/455

(52) U.S. Cl. CPC H04L 9/50; H04L 9/0894; H04L 9/3236; H04L 9/0825; H04L 69/162; G06F 9/45558; G06F 2009/45587; H04L 2209/463

(57) ABSTRACT

A system and method for distributed settlement of a transaction among a plurality of participants without smart contracts is disclosed. The method utilizes a system that includes: a plurality of blockchains each having a plurality of nodes; and a coordinator for transferring messages between the nodes and maintaining status values so that all operations of the transaction are either committed or rolled back. The method includes: receiving a request for the transaction generated from one of the participants; posting the transaction request on a billboard; reading the transaction request by the nodes from the billboard; synchronizing among the participants; receiving transaction votes from the participants to either commit or roll back the request; and executing the transaction based on the transaction votes by either committing transaction or rolling back the request.

This application claims the benefit of U.S. provisional application No. 62/888,091 entitled “Method and System for a Decentralized Transactional Communication Protocol” filed on Aug. 16, 2019 and international application No. PCT/CA2020/051065 entitled “Distributed Blockchain Transaction System” filed on Aug. 5, 2020, the contents of each of which are hereby incorporated herein by reference. This application also claims the benefit of international application No. PCT/CA2020/050056 entitled “A Method for Generating Random Numbers in Blockchain Smart Contracts” filed on Jan. 20, 2020 the contents of which is incorporated herein by reference.

### TECHNICAL FIELD

The present application relates generally to a blockchain system, and in particular to distributed blockchain transactions employing multiple blockchains.

### BACKGROUND ART

Blockchain systems maintain a reliable record of transactions by means of collective participation and consensus among participants. A blockchain can be described as a distributed ledger technology (DLT), jointly maintained by multiple networked devices called nodes. A blockchain can thus be thought of as a distributed, tamper resistant, storage system.

Transactions on blockchains require distributed consensus communication among several different participants. These participants do not need to know or trust each other. Participants can also run multiple transaction requests and chain transaction settlements simultaneously. This creates a very asynchronous environment where participants should generate the transaction request bid and a third party should generate the transaction chain bids. Moreover these should be done without compromising the trust-less characteristics of the system.

To prevent malicious activities such as a distributed denial of service (DDOS) attack, malicious code injections, or other malicious behavior in such an environment, especially from participating nodes, layers handling transaction request and transaction chain must be heterogeneous while still being able to interact asynchronously.

In addition, distributed transactional systems should be scalable. Historically, one of the most significant problems of Distributed Ledger Technologies (DTL) is the scalability of these networks. Scalability is generally approximated by the number of transactions per unit of time—e.g., transaction per second (TPS)—that can be processed. While some technologies such as Lightning Network and State Channels aim at resolving this issue, there are limitations that stem from the protocol-centric way these technologies are built—generally being associated with only one or at most a few protocols.

Accordingly, there is a need for improved systems and methods to mitigate at least some of the aforementioned problems in blockchain based systems.

### SUMMARY OF INVENTION

In accordance with one aspect of the present invention, there is provided a method for distributed settlement of a transaction among a plurality of participants, in a system without smart contracts, the system including: a plurality of blockchains each having a plurality of nodes; and a coordinator for transferring security messages between the nodes and maintaining status values to coordinate the transaction so that all operations of the transaction are either committed or rolled back, the method including: receiving a request for the transaction generated from one of the plurality of participants; publicly posting the transaction request on a billboard; reading the transaction request by the plurality of nodes from the billboard; in a preparation phase, synchronizing among the participants and voting to confirm verification of the preparation phase; receiving transaction votes from the participants to either commit or roll back the request, in a commit phase; and executing the transaction based on the transaction votes by committing transaction or rolling back the request.

In accordance with another aspect of the present invention, there is provided a system enabling multiple participants to exchange one or more of assets and data using a first protocol and a second protocol simultaneously, the system comprising: a plurality of blockchains, each blockchain having a plurality of nodes; and a coordinator for transferring security messages between the nodes and maintaining status values to coordinate the transaction so that all operations of the transaction are either committed or rolled back, the system adapted to perform the steps of: receiving a request for the transaction generated from one of the plurality of participants; publicly posting the transaction request on a billboard; reading the transaction request by said plurality of nodes from said billboard; in a preparation phase, synchronizing among said participants and voting to confirm verification of the preparation phase; receiving transaction votes from the participants to either commit or roll back the request, in a commit phase; and executing the transaction based on the transaction votes by committing transaction or rolling back the request.

In accordance with another aspect of the present invention, there is provided a non-transitory processor-readable medium having contents adapted to cause a system to perform operations, the system including: a plurality of blockchains, each blockchain having a plurality of nodes; and a coordinator for transferring security messages between the nodes and maintaining status values to coordinate the transaction so that all operations of the transaction are either committed or rolled back, the operations including: receiving a request for the transaction generated from one of the plurality of participants; publicly posting the transaction request on a billboard; reading the transaction request by the plurality of nodes from the billboard; in a preparation phase, synchronizing among the participants and voting to confirm verification of the preparation phase; receiving transaction votes from the participants to either commit or roll back the request, in a commit phase; and executing the transaction based on the transaction votes by committing transaction or rolling back the request.

In accordance with one aspect of the present invention, there is provided a system that enables multiple participants to exchange assets/data from the same protocol, at the same time as other protocols, and off-chain, thus posing as an alternative to Lightning Network or State Channels.

In accordance with another aspect of the present invention the system enables scalability for off-chain Transactions using parallelization, multi-threading and Chain Transactions.

In accordance with another aspect of the present invention the system is protocol-agnostic and can deal with any permission-based and public ledger, supporting smart contracts or not, either currently in existence or in the future.

In accordance with another aspect of the present invention the system uses a transactional communication protocol and distributed consensus mechanism.

In accordance with another aspect of the present invention the system is uses an Unspent Transaction Output (UTXO) Proof and Byzantine Fault Tolerance method because the Rollback Commitments are performed if the delay of any Chain Transaction goes beyond the fault-tolerance threshold.

In accordance with another aspect of the present invention the system is decentralized and uses nodes with an incentivization model for optimized Chain Transactions. The larger the Chain, the better the commission share.

In accordance with another aspect of the present invention the system of nodes is algorithm-agnostic, enabling participants to create better-performing models on their own which is supported by the economic model for the system.

### BRIEF DESCRIPTION OF DRAWINGS

In the figures, which illustrate by way of example only, embodiments of the present invention,

FIG. 1 is a schematic block diagram illustrating Atomic Swap Infrastructure Layers;

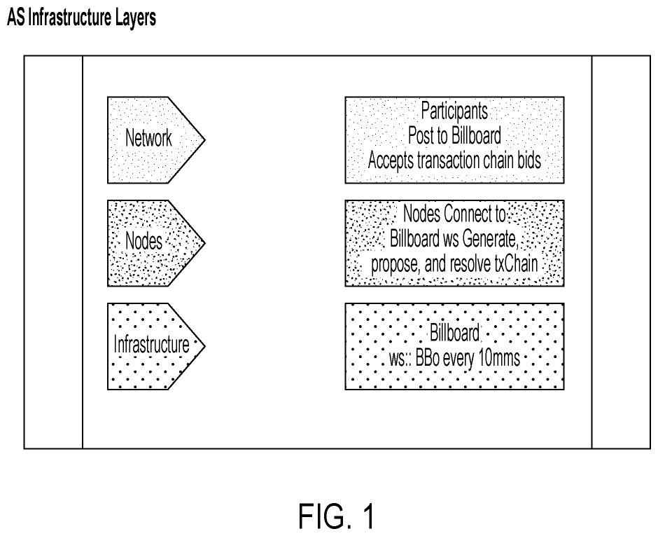

FIG. 2 is a schematic block diagram illustrating participants post transaction requests to Billboard Object (BBo);

FIG. 3 is a schematic block diagram illustrating nodes read the txRequest ABI;

FIG. 4 is a schematic block diagram illustrating how participants exchange unique hashes;

FIG. 5 is a schematic block diagram illustrating how participants acknowledge they are synchronized;

FIG. 6 is a schematic block diagram illustrating participants vote Preparation Phase Status;

FIG. 7 is a schematic block diagram illustrating how a node initializes escrow multisig wallet using success vote as a prompt;

FIG. 8 is a schematic block diagram illustrating Commit Phase is executed by the participants;

FIG. 9 is a schematic block diagram illustrating node or participant verification;

FIG. 10 is another schematic block diagram illustrating verification voting;

FIG. 11 is a schematic block diagram illustrating the Execution Phase;

FIG. 12 is a schematic block diagram illustrating TxChain Cleaning Phase;

FIG. 13 is a schematic block diagram illustrating Rollback;

FIG. 14 is a diagram depicting node Economic Model;

FIG. 15 is a diagram depicting Fractionalization of txRequests Bids;

FIG. 16 is a diagram depicting Transaction Bridge (txBridge)—Bridge Initialization; and

FIG. 17 is a diagram depicting Transaction Bridge (txBridge)—Receipt Exchange.

### DESCRIPTION OF EMBODIMENTS

The present disclosure describes a method of creating a highly-scalable smart contract-less communication protocol, much like TCP/IP (Transmission Control Protocol/Internet Protocol), using distributed consensus, an atomic transaction framework, Unspent Transaction Output (UTXO), and a Byzantine Fault Tolerance standard.

The protocol leverages the cross-chain, multi-chain particularities of ZeU Crypto Networks Inc.'s Atomic Swap and relies at least in part, on a method and system for completing cross chain transactions as described in the above-noted U.S. provisional patent application serial No. 62/883,531 entitled “Distributed Blockchain Transaction System” filed on Aug. 6, 2019, the contents of which are hereby incorporated herein by reference.

Smart contracts are an exciting and powerful technology but have historically had scalability and interoperability limitations. Once a system is integrated with a specific protocol, it is difficult to port the system to another protocol. In the context of a high throughput exchange of assets or data, the cost and delay associated with the underlying protocol can cause costs associated with digital asset costs to vary with asset volatility.

Each transaction in a blockchain has one or more transaction outputs (TXO) which serve as sums of spendable amounts for the new owner. These unspent sums are called Unspent Transaction Outputs (UTXO). They remain UTXOs until the new owner redeems them to pay someone else.

As noted above, transactional distributed consensus communication is made by n participants that do not know or trust each other but may run multiple transaction requests and Chain Transaction settlements simultaneously and/or continuously. This creates a very asynchronous environment where participants should generate transaction request bids and a third party should generate transaction chain bids, but without breaching the trust-less architecture or promise of the infrastructure.

Furthermore, to avoid a distributed denial of service (DDOS) attack, malicious code injections, or other forms of cyberattack, especially from participating nodes, the transaction request and Transaction Chain layer must be heterogeneous while still being able to interact asynchronously.

One of the most significant problems of Distributed Ledger Technologies (DTL) is the scalability of their networks. The performance scalability may be generally measured in terms of the number of transactions per second (TPS) the networks can process at any given time. Solutions such as Lightning Network and State Channels are attempts at resolving this issue. The limitations stem from the protocol-centric way the technologies are built which are generally associated with only a single protocol or a limited number of them.

At least some methods exemplary of embodiments of the present invention, obviate the need for a smart contract deployed on a public or permission-based ledger. The hash exchange consensus mechanism is leveraged to create a future-proof method to virtualize the exchange of one or more of assets and data. Exemplary embodiments of the method described herein provide improved scalability and adaptability making the infrastructure as a whole protocol-agnostic and in some ways future-proof

Communication channels created in the embodiments described run in a distributed manner using each participant's virtual machine (VM), and each Transaction Chain in a process. Multiple processes can be spawned at the same time and multi-threading enables cooperative process execution.

In one exemplary embodiment, the VM process is executed in a machine language, such as C# or an equivalent, but the parallelization and multi-threading are wrapped in a compiler language, such as Java. Each concurrent Transaction Chain a participant runs is in parallel, and the total of the User VM processes spawned shares the load of process execution, making the system fast and reliable.

An infrastructure that includes a decentralized billboard and the nodes help maximize the scalability, efficiency, and speed of an off-chain transactional distributed consensus communication protocol. As will be described in detail, the protocol used leverages local virtual machines from the participants and nodes to settle the Preparation Phase and their agreed terms or rollback these commitments at the Commit Phase.

The infrastructure has one or more of the following characteristics: (a) uses memory-based queue handling for asynchronous and heterogeneous communication between participants and nodes; (b) enables participants to run concurrent and co-ed processes to maximize the efficiency of high-speed trading; (c) enables participants to run nodes and participate in the Transaction Chain Bid market, thus incentivizing optimization and scalability in a fully decentralized environment; and (d) enables participants within a single specific ledger to participate with other participants of the same leger, for example, BTC to BTC, which enables high-speed off-chain Transaction Chains, thus simulating Lightning Network capability in a cross-Chain and multilateral context, i.e., protocol-agnostic and n-participants in any Transaction Chain.

The exemplary method resolves the scalability challenge as any local participant's VM can run n-nb of process (nPs) which involve n-nb of participant (nPt). The transactions per second (TPS) would be roughly equivalent=nPs*nPt. Furthermore, multi-threading enables multiple local VMs to cooperate on one process execution, thus making it even faster. Additionally, the transactional distributed consensus communication channels create a smart contract-less environment where strong but slow and costly consensus technology such as Proof-of-Work (POW) is not necessary. Instead, Proof-of-Stake (POS) is used is some form within the nodes' economic model.

Exemplary methods described below detail steps for utilizing the present assignee's cross-chain, multi-chain system within a contract-less VM environment following a UTXO and an atomic standard, as disclosed in the aforementioned U.S. provisional patent application No. 62/883,531 entitled “Distributed Blockchain Transaction System”, that can be executed (i.e., request succeeds or fails) within a predetermined time of for example, one (1) second, thus enabling high-volume trade. The result of any single transaction, whether using digital assets or not, is either a success or a failure.

The method describes a decentralized infrastructure of the following participating actors: (a) participants that generate Transaction Request Bids; and (b) nodes that generate Transaction Chain Bids. The participants are referred to as Users who post a transaction request, i.e., a Bid, on the Transaction Bid queue.

The nodes are connected to a continuous Transaction Request List using a memory-based queue handler, such as ZeroMQ. The nodes are in a constant contest to optimize any Transaction Chain. The node's autonomous agent submits its Chain as a Transaction Chain Bid.

In one exemplary method, each participant runs a local virtual machine (VM) in the form of an Object that communicates by Web Socket with other participants' VMs using Remote Processing Call (RPC) to send hashes, addresses, functions namespace, function parameters, parameter data type and the like. This communication uses high-performance in-memory task queues, such as ZeroMQ.

When a participant starts the transaction, the participant publicly posts the transaction request or retrieve one publicly posted that matches its trading requirements. The trading requirement can include n participants for a Chain of Transactions to settle each participant's Requested trade, thus closing the loop.

When the decentralized infrastructure relays a transaction request, that creates a Transaction Chain, and initiates distributed consensus settlement for it, i.e., initiates a participant's transaction request in the Transaction Chain.

A Transaction Chain (TxCh) is an object created by a nodes' optimization algorithm autonomous agents. It is a Chain of User Transaction Requests (either assets, data or both) that are matched together. Once a Transaction Chain is created, the VM transaction initiation is started from participant 1 to participant n.

When a Chain of Transactions ID is submitted, the participants synchronize their requests and share communication channels (e.g., WebSocket addresses) and the public key with which to encrypt any further communication.

This method leverages the cross-chain and distributed consensus on local VM methods. The infrastructure can be separated into two main components: (a) the Transaction Request Billboard; and (b) the optimization algorithms.

The Transaction Request Billboard is a Transaction Request objects list which is distributed amongst participating nodes as long as they are connected.

Optimization Algorithm is an autonomous agent, trained for transaction request matching and uses an optimization approach to create the largest Transactions Chains. The algorithm is hosted and operated by a node and submits Transaction Chain Bids.

The first node, which submits any given Transaction Chain, sees the Transaction Chain participants locked within the Transaction Request queue for a maximum predetermined period—e.g., one (1) second. When locked, the associated transaction requests are frozen and cannot be submitted by other nodes, which gives time to the algorithm to initiate the first participant's transaction request.

A single Transaction Chain is optimized by having as many participants in it as possible, which serves to further incentivize scalability from the nodes network. Nodes are incentivized by earning a larger commission on the settlement via a payment process in which fees are collected amongst all participants; the more participants in a single chain, the more fees there are. This economic model ensures that running profitable nodes implies running as many Transaction Chains as possible with each chain being as long as possible.

The method leverages the local VM environment of the participants to optimize processes run on the machine level (bytes) by wrapping them into a parallelized multi-threaded environment able to load balance and run a high number of concurrent or co-ed processes.

The method is separated into three phases: (a) Preparation Phase; (b) Commit Phase; and (c) Execution Phase.

User starts the Preparation Phase, verifying that each participant shared the authentic transaction chain application binary interface (txChain ABI), an exchange of unique hashes, and the cryptographic signature of the node is authentic.

Each participant votes on the validity of the Preparation Phase. Once done, Users are considered synchronized for each User-related function, i.e., User Transaction Request such as 10 Ether for 12 EOS, and the Rollback function are considered as Commitments.

These Commitments are executed in the Commit Phase. Once participants post the transaction vote on the Commit Phase, it is either a success or failure.

Failure automatically invokes the Rollback Commitment of each participant. Failure to return a communication or signal failure of the Commit Phase within a specific time period also activates the Rollback Commitment.

If the Commit Phase vote is successful, the Execution Phase is initiated. The Commitments are executed.

If the Transaction settlement (Commitments) is a success, the Transaction Chain-associated node uses this Execution Phase status report as a Receipt to claim its commission from the network, and the associated transaction requests are resolved.

If the Transaction settlement is a failure, the associated transaction request are not resolved and are unlocked for other nodes to claim it within their Transaction Chain Bids.

These phases prevent the double spending of an asset by using a set of local multisig digital wallets and a Rollback function.

The system has a Byzantine Fault Tolerance based on a timeout delay calculated by the executing nodes. The fault tolerance is also proportional to the length of any txChain using 1 second for 3 participants as a basis. This calculation is performed by the node.

Upon success, the system settles a unique transaction on every ledger participating in the transaction.

Upon failure, the transaction activates the Rollback function, all assets/data are returned to the sender with a failure status. There are two types of failure events: soft failure in Preparation Phase where no assets are data were committed, thus the transaction does not proceed; and hard failure in Commit Phase which triggers Rollback from the Rollback Commitments. Finally, two methods namely: Fractionalization of txRequest and Transactional Bridges, enable even greater scalability and can tackle use cases such as high-volume trading, micropayments, big data and the like.

The foreseen weakness of such a system is based on the centralization standpoint of a standard cloud virtual machine.

### 1. System Layers

The communication system protocol is decentralized to ensure that it remains trust-less. In one embodiment, the protocol includes three layers, namely: the network layer, the nodes layer and the infrastructure layer.

### 1.1. The Network Layer

The Network Layer is the sum of all participants submitting transaction requests to the Billboard. The participant starts by creating a trade Request, posting it and within a few seconds confirming its action or not.

On the participant side, a Request for a specific transaction was sent. The soft failure and Rollback are never seen or experienced by the participant unless there is a connection delay after the verification phase vote. This is non-revocable, meaning that the participant can claim the assets and/or data using the verification vote as a Receipt. The verification vote is signed cryptographically by participants and is very hard to fake.

To participate, an interface needs to connect to the Web Socket address and communicate within the frame of and method of the protocol. WebSocket is a web technology providing for bi-directional, full-duplex communications channels, over a single Transmission Control Protocol (TCP) socket.

### 1.2. The Nodes Layer

The Nodes Layer is the sum of all participating nodes connected to the network. Nodes are decentralized actors that mine the network by generating, submitting, and resolving Transactions Chains (txChain), which are made of transaction requests (txRequest) or sustaining Transaction Bridge.

A node is incentivized to participate by earning a commission fee from the txRequest it resolves within a txChain. The longer the txChain, the more fee Bids are collected. The nodes never hold the asset/data but play a mediator role in the contract term agreement between participants. The node receives 90% of the fee Bids. The node is responsible for sending 10% of the commission at predetermined intervals (e.g., every 60 minutes). This is meant to optimize the fee cost and allow for some flexibility on the nodes side. The risk is therefore limited to the duration of the predetermined interval (e.g., 60-minute) commission volume. Failure to do so is grounds for blacklisting.

The node needs to whitelist by using a KYC/AML (Know Your Client/Anti-Money Laundering) method, which attaches a legal name to the responsible party, to the network before it is able to generate txChain Bids. To do so, the node needs to Stake (i.e. deposit into a controlled escrow wallet), an amount of assets representing the transaction limit for any txChain.

If a node is caught lying or goes offline, thus withholding funds, the txChain fails, Rollback fails, and the Stake is used to compensate participants. The node is then blacklisted.

### 1.3. The Infrastructure Layer

The Infrastructure Layer is the only centralized part of the infrastructure or system. It manages the Billboard & LOCK objects. The Infrastructure or system also generates at predetermined interval cycles (e.g., a 24-hour cycle) new cryptographic signature, for which the public key (“pub_key”) is disclosed publicly, and that is used to sign each Billboard txRequest submitted, which is meant to deter spoofing.

In the described embodiment, the infrastructure or system uses a high-performance memory-based queue system to optimize the protocol communication latency.

### 2. The Transaction Chain Bids—Step 1

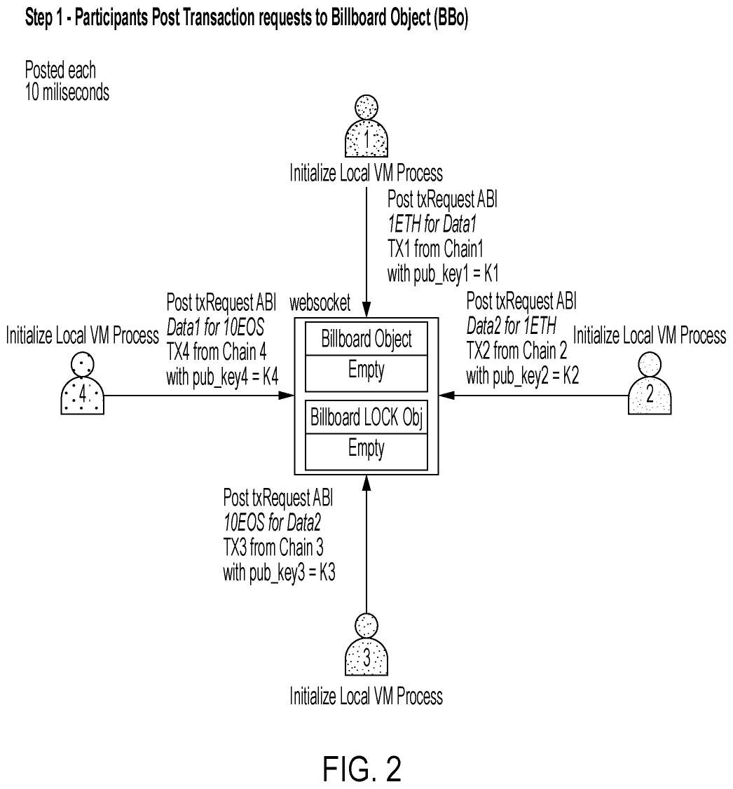

FIG. 2 depicts a schematic diagram of participants post transaction requests to Billboard Object (BBo).

### 2.1. Generate a Transaction Request (txRequest)

Initially each participant initiates their VM contract in their local environment using their protocol associated sender address, i.e., any digital wallet address.

The first participant initiates the transaction request by passing a Transaction Request Object to its VM.

The Transaction Request Object includes:

(a) Function namespace tuple, when function is in instruction-detailed parameter and type is available in the ABI. Note that this place is meant to disclose the parameter namespace and type in order to create a Promise. The Promise makes it easier for the User's VM to interpret, verify, and execute the functions.

(i) Functional parameters;

(ii) Parameters data type;

(b) UnHID tuple;

(c) pub_key;

(d) The Transaction Request Object (Request, Rollback) tuples;

(i) The Request object contains a function namespace and its parameter, for example in solidity (Ethereum comling language) smart contract, the classic transfer function: transfer(unint sender(coordinator address), unint target(target address)). Note that the namespace(*param) structure is used to allow for both asset and data to be handled at the participants' will using data. Smart contracts require specific parameters and the sender's or target address to be included to not return an error.

(ii) If an asset is committed to the transaction request, the transaction request instruction is placed there (e.g., sender address, 1ETH, target address, 10EOS).

(e) The Rollback instruction is automatically generated by the node at escrow multisig digital wallet initialization and contains reverse instructions.

The object uses tuples, or equivalent, for the immutability of the list order and the optimization of processing this list.

The local VM produces an ABI from each function in bytes:

Example: For a three-function contract:

```
ABI = {
' func: [
bytes(keccak256(“function A ((var A, var type A),
(varB, var type B),(varC,var type C))”),
bytes(keccak256(“function B((var A, var type A),
(varB, var type B),(varC,var type C))”),
bytes(keccak256(“function C ((var A, var type A),
(varB, var type B),(varC,var type C))”),
],
UnHID: [
bytes(keccak256( tuple( H1, WebSocket address) ))
]
pub_key: bytes(keccak256( public key generated from UnHID seed )),
Request: bytes(keccak256( {
  sender: sender address,
  target: target address
})),
Rollback: [
  sender: target address,
  target: sender address
]
}
```

Once the ABI is input as parameters, it is considered as a transaction request.

### 2.2. Post on the Billboard

Participant posts a transaction request Bid on the Billboard. The transaction request (txRequest) ABI is cryptographically signed by the participant generating it. The 24-hour cycle Billboard signature also signs it, which ensures that the txRequest ABi is authentic.

Example: Billboard object states:

```
let BBo = {
  RtxBid: [
  ],
  ChtxBid: [
  ],
},
User1(txRequest == 1BTC for uniqueFunctionTriggerA(data)),
User2(txRequest == 100ETH for 1BTC)
User3,(txRequest == uniqueFunctionTriggerA(data) for 100eth)
Node1,
Node2
```

107 Participants submit Transaction Request Object ABIs.

User1 post rtx1=txRequest(User1) ABI publicly to BBo, User1 push Rtx1 to RtxBid list/array.

User2 post rtx2=txRequest(User2) ABI publicly to BBo, User2 push Rtx2 to RtxBid list/array.

User3 post rtx3=txRequest(User3) ABI publicly to BBo, User3 push Rtx3 to RtxBid list/array.

108 Now the BBo object should look like this:

```
BBo = {
  RtxBid: [
    Rtx1,
    Rtx2,
    Rtx3
  ],
  ChtxBid: [
  ],
  Lock: [
  ],
},
```

In one embodiment, the BBo is asynchronously posted to the Network every 10 milliseconds as is.

### 3. The Transaction Chain Bids—Step 2

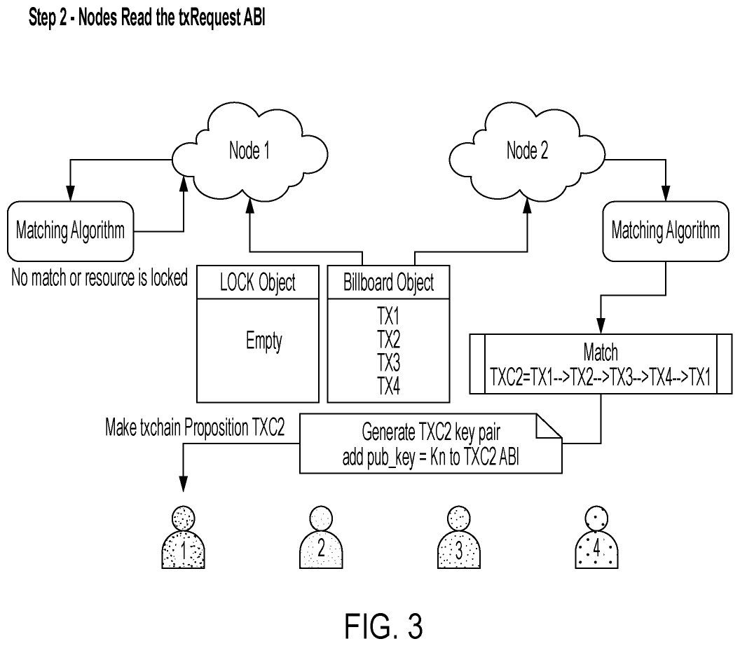

FIG. 3 schematically illustrates how nodes read the txRequest ABI.

### 3.1. Matching Algorithm Feed

Node1 and Node2 listen to BBo posts on the Network WebSocket.

Both nodes run a matching algorithm on their side that takes the BBo txRequest list/array as input parameters and output Transaction Chain Bids.

Node2 also matches a Chain: LastUpdatedBBo(Each(10 mms)BBo)→Algo(Nodes2)→TXC2=TX1→TX2→TX3→TX4→TX1;;

Node2 submits the txChain Bid; this sends a ping signal to an arbitrary first participant in the prospective Chain of tx.

Node2 signs the txChain ABI as it goes to LOCK object, identifying the nodes to which the txChain-locked txRequests belong.

### 3.2. Ping Transaction Chain Bid to First participant

Node2 pings Userl and populates the Chain Transaction txRequest ABI with User1, User2, User3, User4 values.

The participants are technically synchronized in advance. They still need to vote a Preparation Phase contract using their submitted unique Hash ID (UnHID) to validate that the synchronization is valid for all.

The txChain associated ABI sent to User1 should look roughly like this:

```
ABI = {
' func: [
bytes(keccak256(“function A ((var A, var type A),
(varB, var type B),(varC,var type C))”),
bytes(keccak256(“function B((var A, var type A),
(varB, var type B),(varC,var type C))”),
bytes(keccak256(“function C ((var A, var type A),
(varB, var type B),(varC,var type C))”),
],
UnHID: [
]
pub_key: bytes(keccak256( public key
generated from UnHID seed )),
Request: bytes(keccak256(
H1{
  sender: sender address,
  target: target address
},
H2{
  sender: sender address,
  target: target address
},
H3{
  sender: sender address,
  target: target address
},
H4{
  sender: sender address,
  target: target address
}
)),
Rollback: [
H1{
  sender: sender address,
  target: target address
},
H2{
  sender: sender address,
  target: target address
},
H3{
  sender: sender address,
  target: target address
},
H4{
  sender: sender address,
  target: target address
}
)),
]
}
```

### 4. Calculating the Seed & Exchange of Unique Hashes (UnHID)

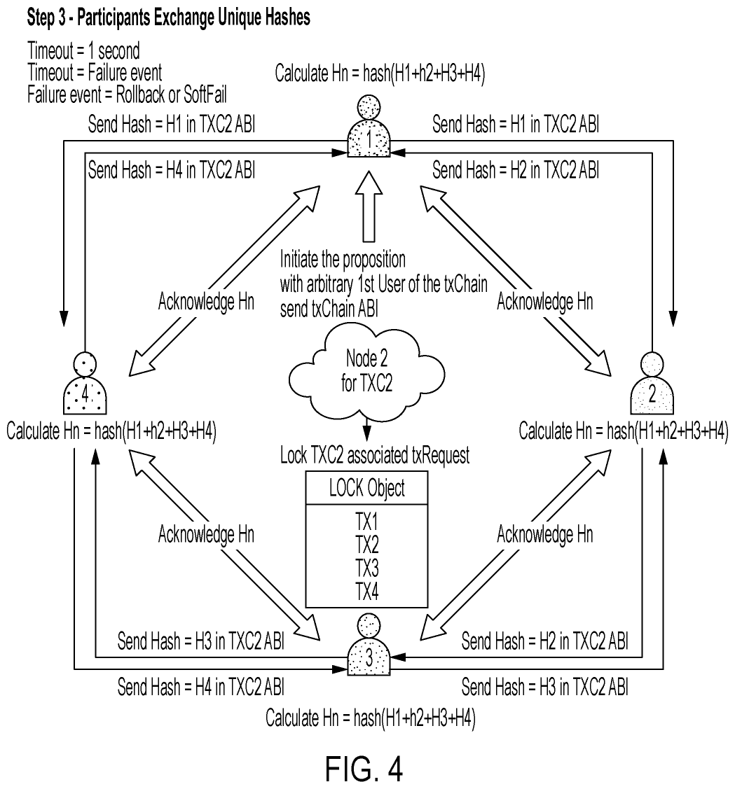

FIG. 4 depicts a block diagram of participants exchange unique hashes.

When a participant receives a txChain Bid ABI, a Transaction Chain is initiated. The ABI contains the necessary information for the User to communicate securely and to challenge the cryptographic signature from the other participants, the node processing the txChain, and the Billboard.

The first participant generates a random number and calculates its hash value, which produces the Unique Hash ID (UnHID). This UnHID is used as the seed to create a key pair used for communication.

Any number of methods for random number generation may be used. In one embodiment, the random number generation method used the method disclosed in U.S. patent application Ser. No. 62/794,336 assigned to the assignee of the present application, entitled “A Method for Generating Random Numbers in Blockchain Smart Contracts” the contents of which is incorporated herein by reference.

### 5. Agreeing to the Transaction Terms

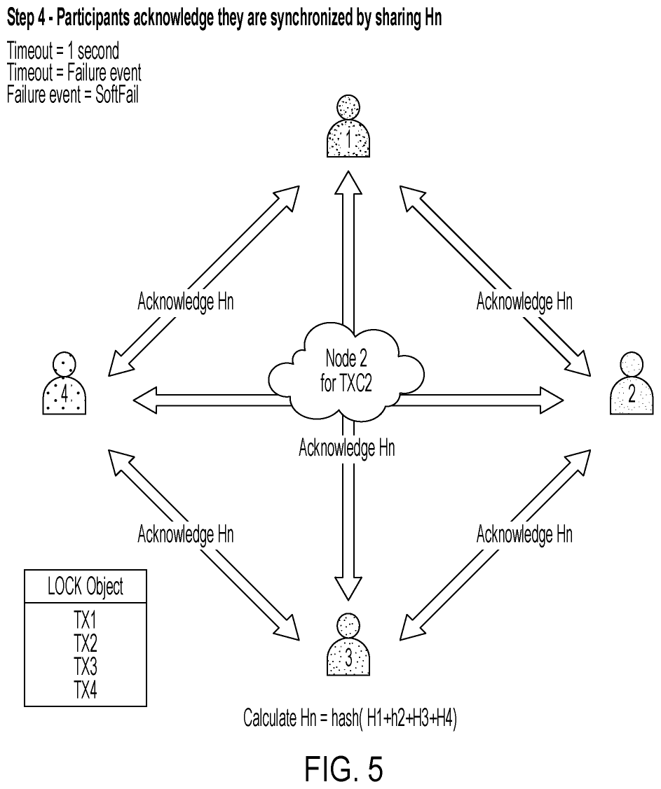

FIG. 5 depicts a diagram illustrating how participants acknowledge they are synchronized by sharing Hn.

The Users exchange the txChain ABI by adding the hash of the sum of all other hashed Hn=hashOf(h1+h2+h3+h4). They validate the txChain ABI.

Each participant sends the Transaction Request ABI to the next participant. Example:

```
Let User1,
User2,
User3
  1. User1's Transaction Request ABI:
      a. User1 posts the Request ABI (which contain User1 UnHID =
          HD publicly on the Transaction Queue;
      b. User2 accepts it;
      c. User2 calculates its UnHID = H2;
      d. User2 pushes H2 to unHID tuple;
      e. User2 pushes Rollback instruction to the Rollback tuple.
  2. User2's Transaction Request ABI:
      User 2 posts the Request ABI publicly on the Transaction Queue;
      a. User3 accepts it;
      b. User3 calculates its UnHID = H3;
      c. User3 pushes H3 to unHID tuple;
      d. User3 pushes Rollback instruction to the Rollback tuple.
  3. User3's Transaction Request ABI:
      User 3 posts the Request ABI publicly on the Transaction Queue;
      a. User4 accepts it;
      b. User4 calculates its UnHID = H4;
      c. User4 pushes H4 to unHID tuple;
      d. User4 pushes Rollback instruction to the Rollback tuple.
  4. User4's Transaction Request ABI
      User4 posts the Request ABI directly to User1;
      a. User1 pushes Rollback instruction to the Rollback tuple.
```

All participants calculate the cHash of the final Request ABI=FcHash; User1 posts FcHash to User2; User2 posts FcHash to User3; and User3 posts FcHash to User1.

6. Performing the Preparation Phase

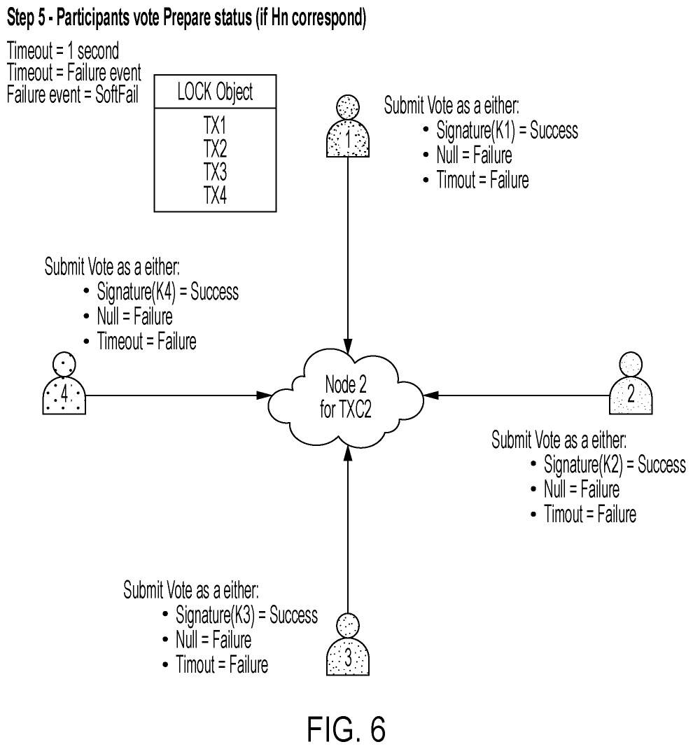

FIG. 6 schematically illustrates participants vote Preparation Phase Status (if Hn corresponds).

If the FcHashes match, the contract terms are considered agreed, and the Preparation Phase of the contract is initiated.

Each participant now has the pub-key and the WebSocket of each other participant, as well as the cHash of the final Transaction Request object. They are considered synchronized.

Each User-associated function and Rollback instructions are considered each participant's Commitment. They are interpreted by the nodes resolving the txChain as a Rollback Commitment if assets were committed into escrow. Each participant votes their judgement of the validity of the terms of agreement, i.e. synchronization.

Each participant evaluates if the hash, i.e., the Preparation Phase statement result, of all participants matches, returns a success status, and votes accordingly. The statement is either a success or a failure.

A success is made using a cryptographic signature to a node's prompt. The prompt state that the User agrees to commits the terms of agreement by depositing any asset or by preparing the cryptographic signature of any data stream. In other words, the participant agrees to the Commit Phase by sending its signature as an authorization for the escrow wallet to execute the Commit Phase.

Participants post the vote to the node; the vote can either be: (1) Success: (cryptographic signature); or (2) Null.

### 7. Performing the Commit Escrow Phase (if an Asset is Involved)

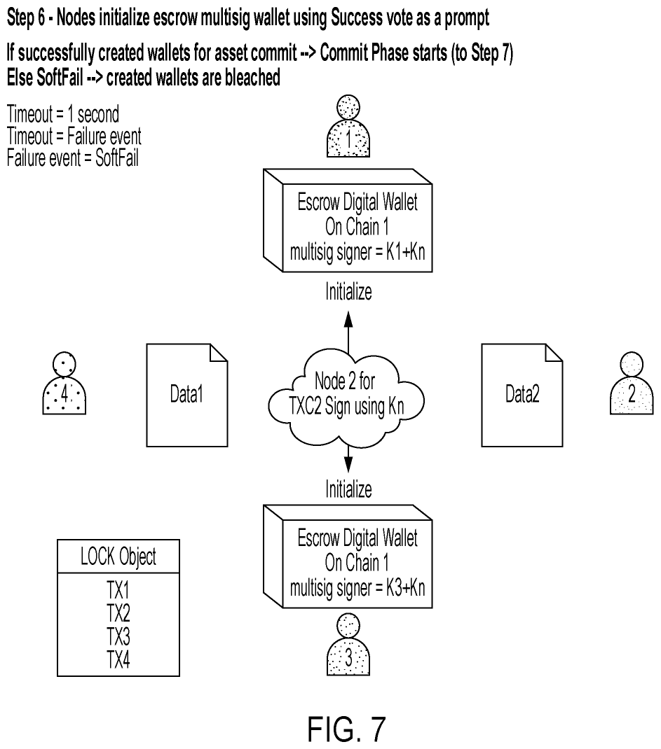

FIG. 7 schematically illustrates how node initializes escrow multisig wallet using success vote as a prompt.

If assets are involved in the txChain, then this Step applies. Once the node receives all the votes, it starts the execution of escrow wallet initialization using two (2) signatures: The node provided txChain pub_key(Kn) and the participant provided pub_key(e.g., K1). If any of the initializations fail, a HardFail event is triggered, and the Rollback Phase is invoked. If all Request wallets are initialized successfully, the node starts the Execution Phase.

### 8. Executing the Commit Phase

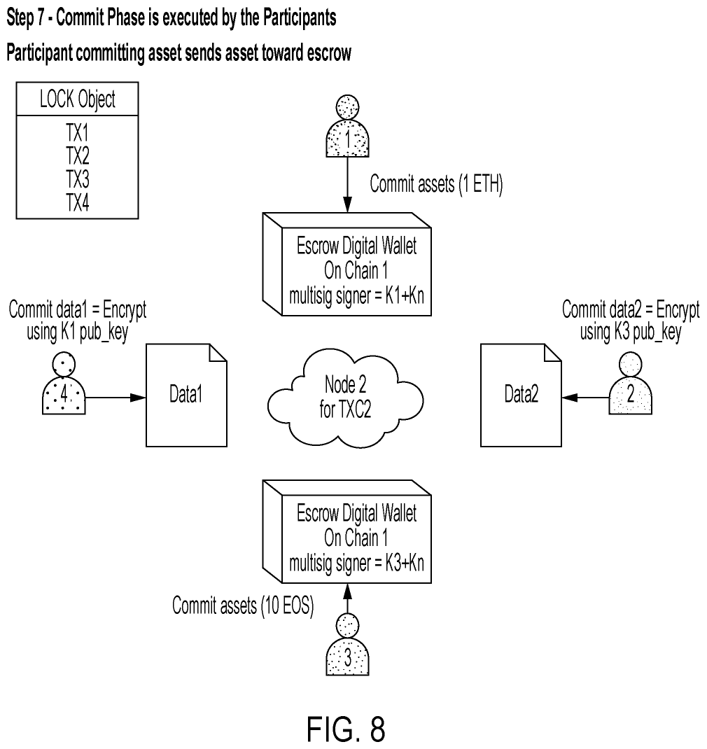

FIG. 8 depicts a Commit Phase as executed by the participants. The nodes start the execution of all User Commitments. The participant with committed assets sends these assets to the escrow multisig wallet created for the participant in this txChain. The participant with committed data encrypts the data with the target pub_key and sign the data with their key. If any of the escrow Commitment Transactions fail, a HardFail event is triggered for all the txChain participants and the Rollback Phase is invoked. Participants without committed assets see their Rollback fail with no Receipt. This is a Soft Fail. If no Commitments fail, the nodes notify the participants to start the Verify Phase.

### 9. The Verify Phase—participants Verify Escrow

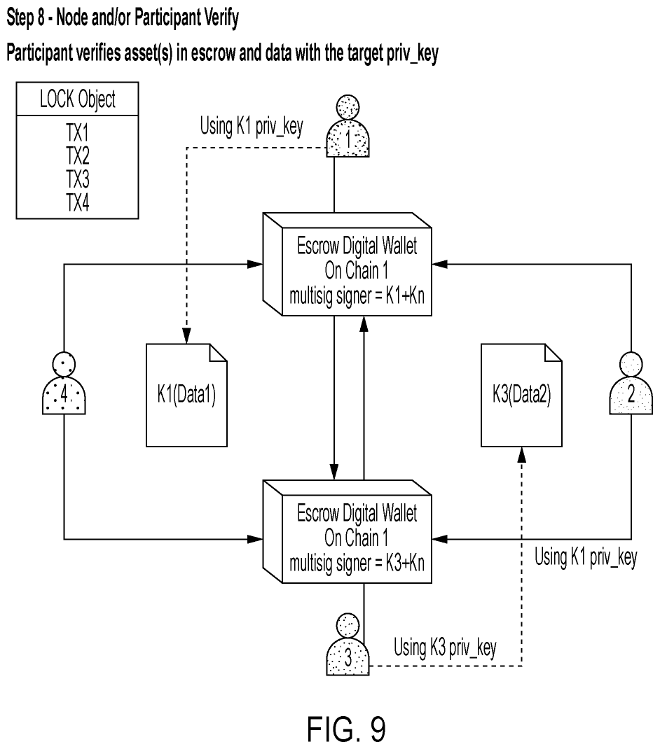

FIG. 9 depicts a diagram that illustrates node and/or participant verification. Each participant evaluates the other participant's committed asset or signed data. The participant can verify the asset deposit as the escrow wallet is disclosed to all participants of the txChain. The participants can verify the data validity by verifying it matches the promised data in the terms of agreement (txChain ABI) and has been signed by the right participant.

### 10. Verify Phase—participant Vote

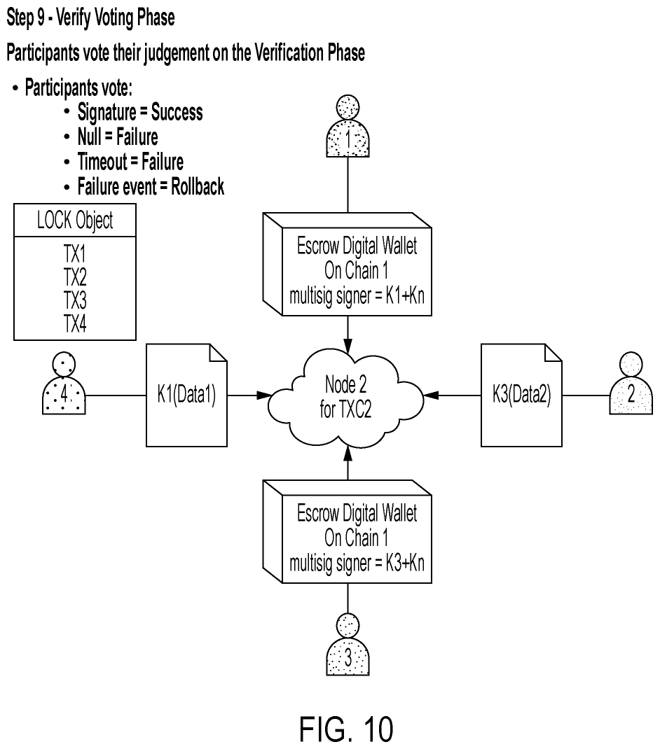

FIG. 10 depicts the process of verification of voting or the ‘verify voting’ phase. Each participant casts a vote on their judgement of the validity of the asset/data. The asset is in an escrow wallet, the data matches the terms of agreement, and is signed by the correct participant. To verify the asset, the participant looks up the corresponding ledger using the escrow address. If the ledger block by txid corresponds to the agreed terms and the txid sent by the node (signed), the Transaction is considered valid even if it was not on the associated ledger. It still appears as a pending Transaction (on the ledger using block explorer) and terms from both executors are proven to be the same.

User1 posts vote (Verify Phase status)=either true (signature) or null to all Users.

User2 posts vote (Verify Phase status) =either true or false to all Users.

User3 posts vote (Verify Phase status) =either true or false to all Users.

If the unanimous vote is affirmative, the Verify Phase is considered successful, and the Execution Phase is started.

The Pre-Execution Phase of the txChain is run on a Timeout delay of a base of 1 second, which is proportionally modified with the length of the txChain. This accounts for a dynamic Byzantine Fault Tolerance Policy. At this stage, if any participant lied, it is seen by all other participants and the node. If a node lies, it is also caught as Commitment cannot be fulfilled in escrow.

### 11. The Execution Phase

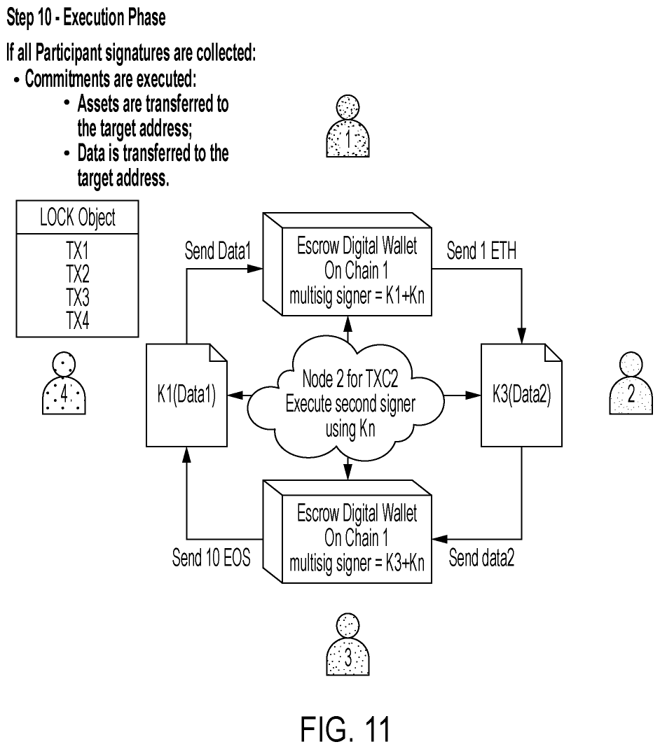

FIG. 11 schematically depicts the Execution Phase.

When the Execution Phase is executed, the node uses the Verify Phase vote signature as authorization to execute each participant's Commitment. Each time a Commitment is executed, the node sends a signed Receipt to the corresponding target participant. Note that in execution, the nodes also perform a second Transaction which is sending the fee Bid to its node's target wallet. The participant can verify if the Receipt corresponds to their requested target address, i.e., the address where they requested the traded asset to be sent, and if the Transaction is valid. The participant sends their judgement on the validity of the txChain with either: (a) a signed Receipt of txid; or (b) Null.

### 12. Transaction Chain Settlement

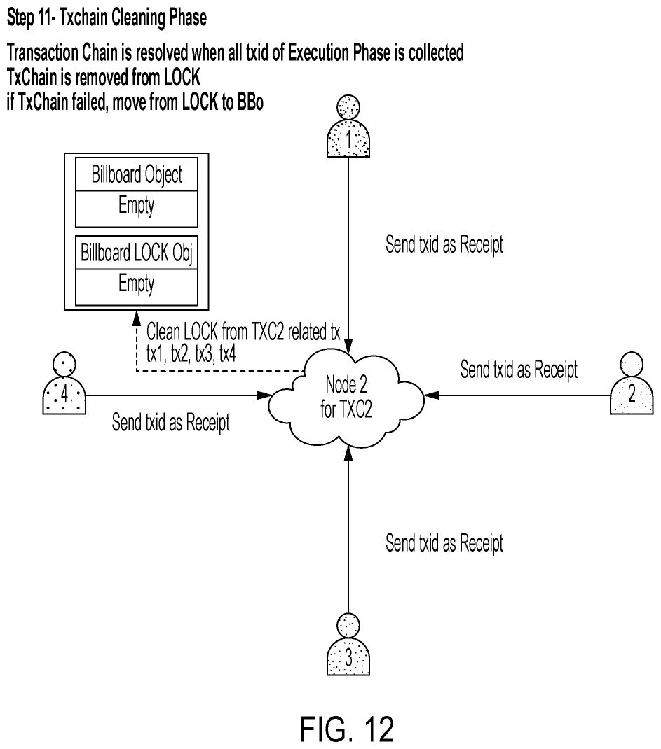

FIG. 12 depicts a TxChain Cleaning Phase.

### 12.1. Transaction Chain Settlement (Resolution)

To settle the txChain, a node needs to provide all participants' signed txid and sign the txChain locked resource in the LOCK object to delete it. A node caught cheating and deceiving the participant into sending the asset into a false escrow or which does not execute the Commitment successfully or which provides a wrong Receipt within the Transaction Timeout delay loses its Stake and is blacklisted. Participants claim compensation by presenting their vote Receipt to the Billboard.

The Billboard keeps a hash Hb=hash(txid of each participant), sign(Hb) to claim the infrastructure fee to the node in the next 60 minutes cycle. Now the BBo object should look like this:

BBo = {
RtxBid: [
],
ChtxBid: [
],
Lock: [
],
},

### 13. The Rollback Phase

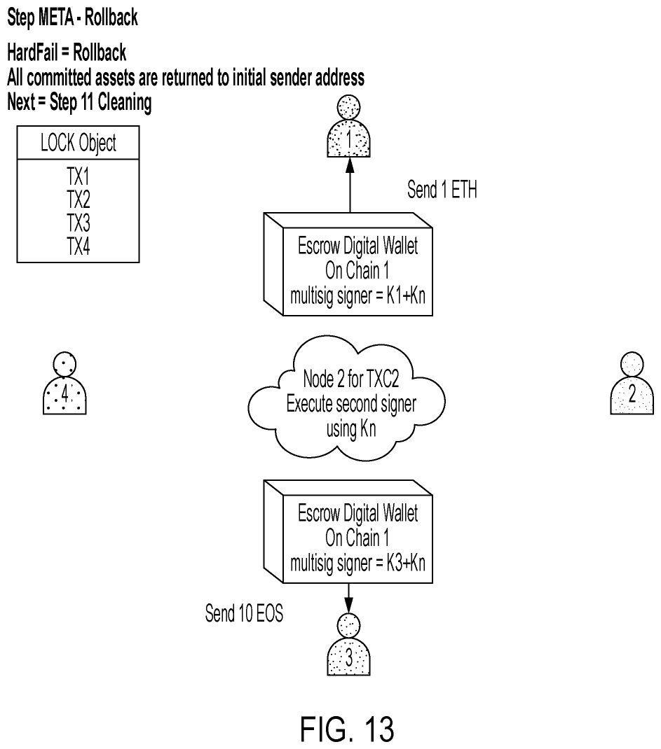

FIG. 13 schematically depicts a Rollback step.

If a Rollback is invoked, all Rollback Commitments are executed by the participant and countersigned by the node. If the node does not countersign, the Commitment fails, and the Transaction is not executed. If a participant does not sign the Rollback (either through bad behavior or going offline), its asset is lost and remains in an un-spendable address.

A Rollback event needs an action from the participant. From the participant perspective, there is a second confirmation stating the Transaction failure. If applicable, node failure, i.e., txid failure to match, and the compensation asset from the node Stake is shown. If any Rollback Commitment fails, either through bad behavior or going offline, the node is blacklisted, and its Stake is lost; the participants are compensated.

### 14. Node Economic Model

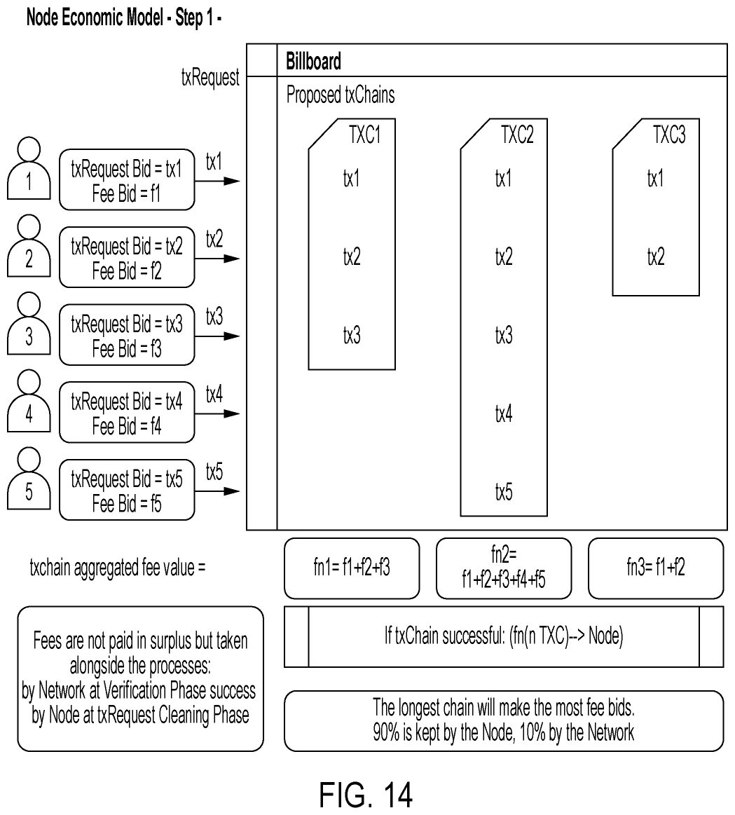

FIG. 14 schematically illustrates an exemplary node economic model.

An exemplary economic model underlying the participation of nodes into the network is described below.

Nodes mine transaction request (txRequest) by generating Transaction Chains (txChain) proposal, i.e., Bids. Participants add a fee proposal (Bid) to their Request. Nodes can view the txRequest ABI and the fee Bid. The nodes are incentivized to optimize the Chain by matching of the longest Chain of trade (txChain) possible. Each time a txChain is executed (Execution Phase) successfully by a node, the node sends the fee to its node target wallet.

### 15. Fractionalization of txRequest Bids

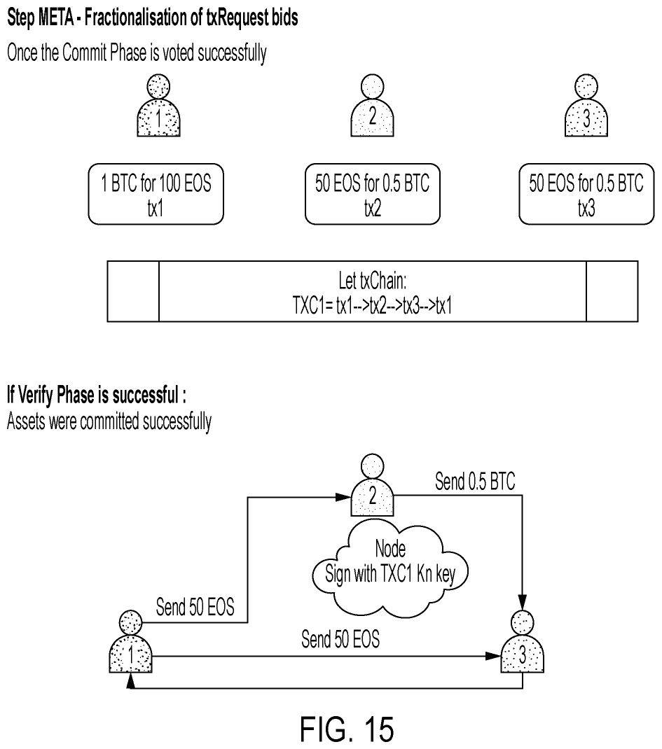

FIG. 15 illustrates Fractionalization of txRequests Bids. Fractionalization of transaction request (txRequest) is a principle which implies that any txRequest offer and ask part can be fractioned to match more participants in the same txChain. When Commitments are executed in the Execution Phase, the Commitments are not forcibly circular. Commitments are a sender, a target address, and an amount associated with it. A participant can agree to a multi-layer agreement in which the same participant sends assets to more than one participant e.g., User1 to User2 and User3. This enables a more fluid and flexible txChain Bid generation.

### 16. Transaction Bridges (txBridges)

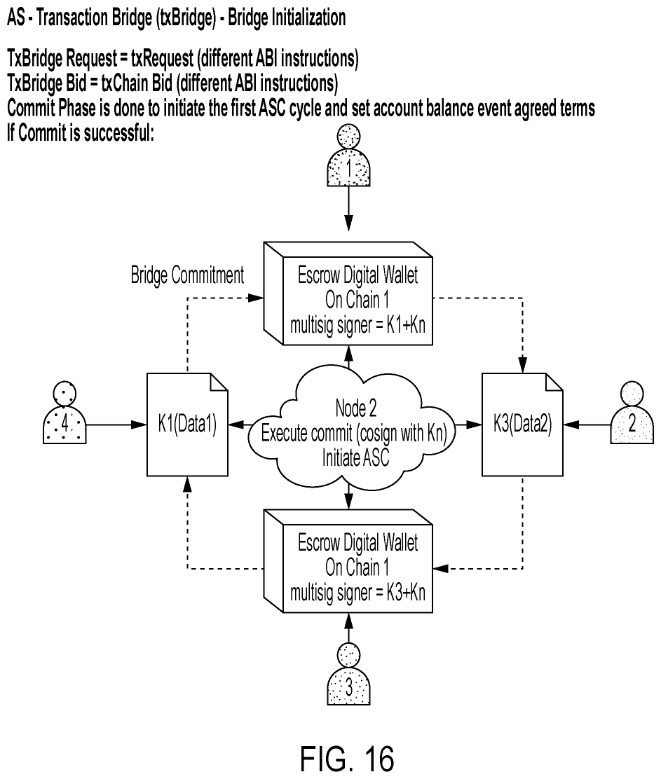

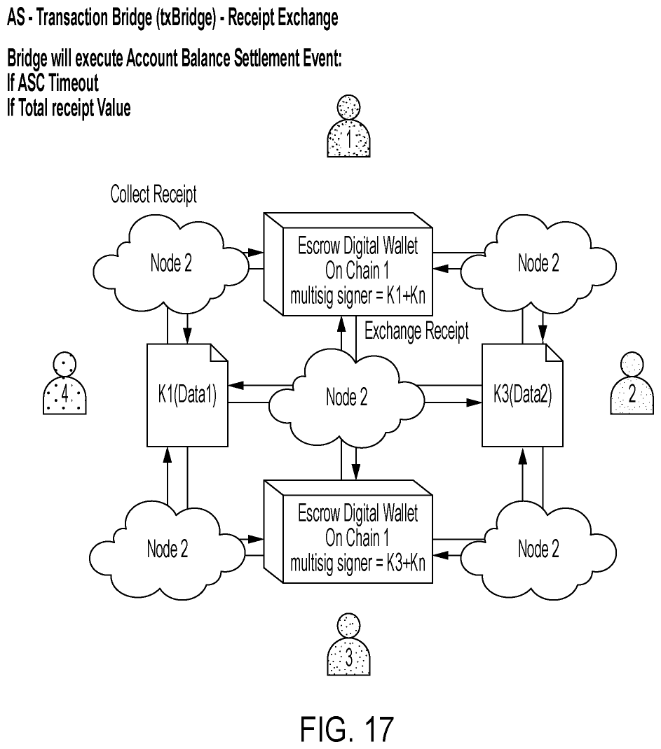

FIG. 16 depicts Transaction Bridge (txBridge)—Bridge Initialization while FIG. 17 depicts Transaction Bridge (txBridge)—Receipt Exchange.

Transaction Bridges (txBridge) are new multilateral off-chain settlement systems which enable use cases such as high-volume trading, micro-transactions, and big data. Transaction Bridges could be described as a settlement system upon which all participants commit assets/data enabling them to exchange Pseudo-Transactions, i.e. cryptographically signed Receipts, at high speed.

When the total amount of trades representing the total committed assets/data or the Time Cycle has passed, the account balances are settled. The Account Balance Settlement is calculated by aggregating the total exchange Receipts.

A hash of the aggregated Receipts enables an efficient one-time check of the balance validity. Note that any Receipt needs to be signed by both the node and the associated participant to ensure its authenticity.

The txBridge is run by nodes in the same manner as it does for normal txChain, but the cycle of fee commissions is based on an Agreed Settlement Cycle (ASC). A txBridge is a variant from the txChain. It follows much of its logic but has several differences. A txBridge is a continuous two-way process of txChain between n-participants. Each participant has an effective Bridge to send and receive assets.

If it follows an ASC cycle that is agreed upon by all participants. The cycle is based on time and ends by the Account Balance Settlement. Each cycle ends with a txBridge cycle settlement, which follows a similar logic as a txChain settlement.

Account Balance Settlement is triggered by one of two conditions: (1) ASC Timeout; and (2) The total Receipt value of any two participants within their Bridge context (E.g., Alice commits 10000 USD worth of BTC and Bob 10000 USD worth of ETH, if the Receipt value >90% of the new refreshed USD (Alice's BTC+Bob's ETH)). As txBridges are based on mutually agreed terms ABIs, the cycle total expected Transaction value is predictable.

Creating a txBridge follow X steps:

```
1. Participants post a txBridge Request ABI the same way
    they would post a txRequest ABI.
    a. Note that txBridges are based on a Time Cycle and
      also a defined time period.
    b. The txBridge ABI contains a terms Request which is
      a frame of the Transaction they want to be enabled within the Bridge.
        i. The terms define which protocol is involved.
2. Nodes match the txbridbge Chain and accept:
3. ASC cycle
    a. Total ASC nb of cycles (total time limit).
4. Nodes propose a txBridge Bid as they would post a txChain Bid.
5. Once the User accepts, the first Commit Phase serves to
  deposit participant-committed funds.
6. Once a Verify vote is successful, the Bridge is considered active,
  and Transactions can start being executed.
7. From that point, participants can send asynchronous calls for Transactions.
    a. participants exchange Receipts which are Pseudo-
      Transactions containing the exchange terms.
8. This process continues until one of two conditions occurs:
    a. Timeout Event;
    b. Account Balance Event.
```

### 16.1. Timeout Event

A Timeout event is called when the ASC cycle has passed in the nodes' perspective. Nodes are in control of this. When a Timeout event is called, the current account Balance proven with a Receipt is exchanged. The participants vote their judgment of the validity of each other's Receipt, exchanging a unique aggregated Receipt hash. If the vote is a success, the Account Balance Transactions are executed. If the vote is a failure due to tx Timeout, no Transaction occurs, and the committed assets/data are not touched. If a failure is due to a participant, the participant's committed fund are used as compensation. If the failure is due to the node, the node's Stake is used as compensation.

### 16.2. Account Balance Event

When an Account Balance Event is triggered, the Receipt value is calculated, and a new Account Balance Proposal is sent to the User. Users vote their judgement of the validity of the Receipt Balance; they can also calculate it from their synchronized Receipt, which they used for hashing. If the outcome of the vote is a success, the transaction is executed. However, if the outcome of the vote is a failure or timeout, no transaction occurs, and the committed assets/data are not touched.

If the failure is due to a participant, the participant's committed fund are used as compensation. If the failure is due to the node, the node's Stake is used as compensation.

### 16.3. Scalability

The volume and nb of Transactions are dependent on the committed funds the participant invests and the length of the ASC cycle.

The advantage of Pseudo-Transactions is that they are lightning-fast and fee-free; the only fees are associated with the Account Balance Settlement event, which allows for a tiny fraction of the asset to be traded without creating a cost explosion.

TxBridge can be run via a fiber-optic connection between the participants and the nodes, thus allowing nanosecond trading/exchange.

### Other Embodiments

As would be appreciated by persons of skill in the art, many alternative embodiments of the present invention are possible. In an exemplary alternate embodiment, there is provided a non-transitory processor-readable medium having contents adapted to cause a system (e.g., a blockchain system) to perform the following operations.

The system includes a plurality of blockchains, each blockchain having a plurality of nodes; and a coordinator for transferring security messages between the nodes and maintaining status values to coordinate the transaction so that all operations of the transaction are either committed or rolled back. The operations include: receiving a request for the transaction generated from one of the plurality of participants; publicly posting the transaction request on a billboard; reading the transaction request by the nodes from said billboard; in a preparation phase, synchronizing among the participants and voting to confirm verification of the preparation phase; receiving transaction votes from the participants to either commit or roll back the request, in a commit phase; and executing the transaction based on the transaction votes by committing transaction or rolling back the request.

Having thus described, by way of example only, embodiments of the present invention, it is to be understood that the invention as defined by the appended claims is not to be limited by particular details set forth in the above description of exemplary embodiments as many variations and permutations are possible without departing from the scope of the claims.

What is claimed is:

1. A method for distributed settlement of a transaction among a plurality of participants, in a system without smart contracts, the system comprising: a plurality of blockchains each having a plurality of nodes; and a coordinator for transferring security messages between the nodes and maintaining status values to coordinate the transaction so that all operations of the transaction are either committed or rolled back, the method comprising:
a) receiving a request for the transaction generated from one of the plurality of participants;
b) publicly posting the transaction request on a billboard;
c) reading the transaction request by said plurality of nodes from said billboard;
d) in a preparation phase, synchronizing among said participants and voting to confirm verification of the preparation phase;
e) receiving transaction votes from the participants to either commit or roll back the request, in a commit phase; and
f) executing the transaction based on the transaction votes by committing transaction or rolling back the request.

2. The method of claim 1, further comprising running a local virtual machine at each of said plurality of nodes.

3. The method of claim 1, wherein said synchronizing comprises at least exchanging unique hashes.

4. The method of claim 1, wherein a Byzantine Fault Tolerant protocol is used in the system.

5. The method of claim 4, wherein a timeout delay calculated by the nodes causes a rollback of the transaction.

6. A system enabling multiple participants to exchange one or more of assets and data using a first protocol and a second protocol simultaneously, the system comprising:
a plurality of blockchains, each blockchain having a plurality of nodes; and
a coordinator for transferring security messages between the nodes and maintaining status values to coordinate the transaction so that all operations of the transaction are either committed or rolled back, the system adapted to perform the steps of:
a) receiving a request for the transaction generated from one of the plurality of participants;
b) publicly posting the transaction request on a billboard;
c) reading the transaction request by said plurality of nodes from said billboard;
d) in a preparation phase, synchronizing among said participants and voting to confirm verification of the preparation phase;
e) receiving transaction votes from the participants to either commit or roll back the request, in a commit phase; and
f) executing the transaction based on the transaction votes by committing transaction or rolling back the request.

7. The system of claim 6, wherein upon said synchronizing, each participant has a public key and Web Socket of each other participant.

8. The system of claim 7, wherein upon said synchronizing, each participant has a hash of a transaction request object associated with the transaction.

9. The system of claim 6, further enabling scalability for off-chain transactions using at least one of parallelization, multi-threading and chain transactions.

10. The system of claim 6, wherein each of said plurality of nodes listens to posts on the billboard via a bi-directional communications channel.

11. The system of claim 10, wherein the bi-directional communications channel is a WebSocket.

12. The system of claim 6, wherein the system is protocol-agnostic and capable of accommodating any permission-based and public ledger, with or without smart contracts, either currently in existence or in the future.

13. The system of claim 6, further comprising a transactional communication protocol and distributed consensus mechanism.

14. The system of claim 6, comprising a Byzantine Fault Tolerant (BFT) protocol.

15. The system of claim 10, wherein unspent transaction output (UTXO) proof is used.

16. The system of claim 11, wherein Rollback Commitments are performed if a delay of the transaction goes beyond a fault-tolerance threshold.

17. The system of claim 6, wherein the system is decentralized and provides the nodes with an incentive model wherein commissions increase with the size of chains.

18. The system of claim 6, wherein the system is algorithm-agnostic.

19. A non-transitory processor-readable medium having contents adapted to cause a system to perform operations, the system comprising: a plurality of blockchains, each blockchain having a plurality of nodes; and a coordinator for transferring security messages between the nodes and maintaining status values to coordinate the transaction so that all operations of the transaction are either committed or rolled back, the operations comprising:
a) receiving a request for the transaction generated from one of the plurality of participants;
b) publicly posting the transaction request on a billboard;
c) reading the transaction request by said plurality of nodes from said billboard;
d) in a preparation phase, synchronizing among said participants and voting to confirm verification of the preparation phase;
e) receiving transaction votes from the participants to either commit or roll back the request, in a commit phase; and
f) executing the transaction based on the transaction votes by committing transaction or rolling back the request.

20. The non-transitory processor-readable medium of claim 19, wherein the contents further comprise operations to implement a Byzantine Fault Tolerant (BFT) protocol.
